(19) United States
(12) Patent Application Publication
(10) Pub. No.: US 2008/0225173 A1
(43) Pub. Date: Sep. 18, 2008

(54) SIGNAL PROCESSING APPARATUS

(76) Inventors: Shuji Miyasaka, Osaka (JP); Yuji Sugisawa, Fukuoka (JP); Akihiro Kato, Kanagawa (JP); Futoshi Morie, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/046,087

(22) Filed: Mar. 11, 2008

(30) Foreign Application Priority Data
Mar. 13, 2007 (JP) 2007-063204

(51) Int. Cl. H04N 5/14

(52) U.S. Cl. 348/571; 348/E05.062

(57) ABSTRACT

A signal processing apparatus capable of efficiently processing bitstream in a small circuit scale includes an input buffer in which a bitstream is stored, a first processor which generates a program for processing a signal B corresponding to a signal A by taking out the signal A from the bitstream stored in the input buffer and by using at least one related signal included in the signal A, the related signal being related to the signal B; and a second processor which acquires the program generated by the first processor and executes the acquired program to process the signal B corresponding to the signal A.

### BACKGROUND OF THE INVENTION

(1) Field of the Invention

The present invention relates to a signal processing apparatus using a main processor and a sub processor, and more particularly to a signal processing apparatus which obtains a compressed coded signal and decodes the compressed coded signal.

(2) Description of the Related Art

In recent years, devices which record Audio Video (AV) signals on a recording medium, read and reproduce the AV signal from the recording medium using Digital Versatile Disc (DVD) and Blu-ray Disc (BD) as the recording medium have been developed. Furthermore, in addition to the recording and the reproduction using the recording medium, appliances simultaneously receive AV signals transmitted via the broadcast wave and transmit and receive AV signals via the network have been developed. Significant amount of computation is required for signal processing such as video codec, audio codec, and communication processing used for such devices and appliances.

To put it differently, recent audio coding technologies require significant amount of computation. For example, in the Advanced Audio Coding (AAC) method according to the Moving Picture Experts Group (MPEG) standard, compressed coded signals are compressed using a variety of Huffman codebooks and structured by a variety of control, the processing for the signals requires significant amount of computation.

Furthermore, the audio coding technology that has been developed recently requires even more significant computation amount (For example, see Non-Patent Reference 1: Zoran Fejzo, “DTS-HD: Technical Overview of Lossless Mode of Operation” presented at the 118th Convention of the Audio Engineering Society, Preprint 6445, May, 2005.)

FIG. 1 is a block diagram showing a configuration of a signal processing device which encodes Pulse Code Modulation (PCM) signals with the audio coding technology in the Non-Patent Reference 1. Note that the Non-Patent Reference 1 has been presented by the DTS, Inc. and the audio coding method described in the reference is known as the DTS.

The signal processing apparatus 300 includes a core encoder 301, a core decoder 302, a residual generator 303, a delay unit 304, a loseless encoder 305, and a packer 306.

The core encoder 301 first generates a coded PCM signal by obtaining a PCM signal and performing regular encoding. Here, the regular encoding represents irreversible encoding also known as lossy encoding (lossy). Since the lossy is encoding having a high compression rate, even when the PCM signal encoded by the lossy is decoded, a reproduced signal generated by the decoding is not fully identical to the original PCM signal. The lossy is currently the most widely used encoding method such as the AAC in the MPEG audio and the MPEG Audio Layer-3 (MP3).

The core decoder 302 generates a decoded PCM signal by locally decoding the coded PCM signal. More specifically, the core decoder 302 decodes the encoding results by the core encoder 301 in the encoding process in the signal processing apparatus 300.

The residual generator 303 generates residual signals by calculating a difference between the decoded PCM signals and the PCM signals delayed by the delay unit 304.

The lossless encoder 305 generates a coded residual signal by compress-coding the residual signal. Here, the compress-coding is capable of fully recovering the coded signal to the signal before coding, which is also known as the lossless encoding.

The packer 306 generates a bitstream (compressed coded signal) by packing the coded residual signal which is the result of the lossless encoding generated as described above and the coded PCM signal which is the result of lossy encoding.

FIG. 2 is a block diagram showing the structure of a signal processing apparatus which decodes the bitstream generated by the audio coding technology of the Non-Patent Reference 1.

The signal processing apparatus 400 includes a separator 401, a core decoder 402, a lossless decoder 403, and a residual embedding unit 404.

The separator 401 obtains the bitstream generated by the signal processing apparatus 300 and separates the bitstream into the coded PCM signals and the coded residual signals.

The core decoder 402 generates the coded PCM signals by decoding the coded PCM signals. The lossless decoder 403 generates a residual signal by decoding the coded residual signals.

The residual embedding unit 404 recovers the bitstream into the fully original PCM signals by adding the residual signal to the coded PCM signal.

Here, conventionally, a signal processing device using multiple processors for performing the signal process at a low operating frequency (for example, see Patent Reference 1: U.S. Pat. No. 6,081,783).

FIG. 3 is a block diagram showing a configuration of the signal processing apparatus including the multiple processors in the Patent Reference 1.

The signal processing apparatus 200 includes two DSPs (Digital Signal Processors), namely, a DSP 200a and DSP 200b. The DSP 200a processes signals by using a program Random Access Memory (RAM) 201a, program ROM (Read Only Memory) 202a, and data RAM 203a, and the DSP 200b processes signals by using a program RAM 201b, a program ROM 202b, and a data RAM 203b. The shared data RAM 204 is a memory to which both of the DSPs can access.

Each of the program RAM 201a, 201b and the program ROM 202a, and 202b, programs necessary for signal processing in each of the DSPs are stored in advance. For example, when the signal processing apparatus 200 decodes audio, the DSP 200a performs a process known as parsing, as the first half of the audio decoding process. In the parsing, the construction of the coded audio signal is analyzed, predetermined signals are taken from the analyzed signal and the signal converted into intermediate signals. The intermediate signals generated by such processing is handed to the DSP 200b side via the shared data RAM 204 and processed by the DSP 200b. For example, the intermediate signals handed from the DSP 200a to the DSP 200b are coefficients of the frequency spectrum in the decoding process, and the DSP 200b converts the coefficients of the frequency spectrum to the temporal axis signal.

However, when the conventional signal processing apparatus 200 shown in FIG. 3 is to decode the compressed coded signal in the AAC and to decode the compressed coded signal in the DTS, there is a problem that the circuit scale of the signal processing apparatus 200 needs to be extended.

More specifically, a large-scale complex Huffman decoding is required for variable length decoding among the decoding compliant to the AAC, MPEG standard.

In other words, the bitstream which are the compressed coded signal in the AAC are constructed with groups of the Huffman codes in a complex manner. In addition, the syntax of the bitstream is represented in a complex manner with, for example, triple “for” loop and branching using “if”. Therefore, parsing the bitstream, more specifically, the process analyzing the bitstream and taking out the Huffman codes from the bitstream and performs the Huffman decoding requires significant amount of processing. More specifically, please see the Non-Patent Reference 1: MPEG (AAC) standard (ISO/IEC 13818-7:2003).

Such parsing requires a variety of Huffman codebooks, and it is also necessary to analyze the data structure by various controls. Thus, in the signal processing apparatus 200 having multiple processors as described in the Patent Reference 1, even if the DSP 200a, one of the DSP performs only parsing, the DSP 200a needs to be a high performance DSP capable of complex processing.

Furthermore, in this case, the DSP 200b needs to be a high performance DSP capable of processing the latter half of the audio decoding process. This results in a large circuit scale, and interrupts cost reduction.

Furthermore, among decoding in the DTS, the variable length decoding must be compliant with signals coded by a variety of variable length coding methods.

Bitstream, which is compressed coded signal in the DTS, includes signals coded in multiple variable length coding methods. More specifically, the core encoder 301 and the lossless encoder 305 respectively switches the multiple types of variable length coding methods, and encodes the signals using the switched variable length coding method. The multiple variable length coding methods include the Huffman coding, the binary coding and the rice coding (See Non-Patent Reference 1, Section 3.2: Entropy coding). Note that only Huffman coding can be used as the variable length coding method for AAC and MP3.

Such decoding of bitstream in the DTS is to be performed by the signal processing apparatus 200 including conventional multiprocessor as shown in FIG. 3, the signal processing apparatus 200 have to include various programs for the first half of the processing in the decoding process, more specifically, for parsing the bitstream. As a result, the signal processing apparatus 200 have to include an extremely large scale of program memory for parsing by the DSP 200a. This extends the circuit scale of the signal processing apparatus 200.

Note that the process for taking the Huffman code and the Rice code from bitstream and decoding the codes are complex, resulting in a large scale signal processing apparatus and increased operational frequency. For example, as disclosed in the section 3.2 of the Non-Patent Reference 1 (Entropy Coding), decoding Rice codes in the DTS method includes processing with judgment and branching such as bit search and sign process. Note that the bit search is for detecting the number of bits with successive “0” in a bitstream, and the sign process is for reversing the sign by detecting a predetermined 1 bit. Thus, significant amount of processing is required for decoding the Rice code.

### SUMMARY OF THE INVENTION

The present invention has been conceived in order to solve the above problem, and it is an object of the present invention to provide a signal processing apparatus capable of efficiently processing a bitstream in a small circuit scale.

In order to achieve the above object, the signal processing apparatus according to the present invention is a signal processing apparatus that processes an input signal in which a first signal and a second signal corresponding to the first signal are alternately packed, the signal processing apparatus including: a storage unit in which the input signal is stored; a first processor which generates a program for processing the second signal corresponding to the first signal by taking out the first signal from the input signal stored in the storage unit and by using at least one related signal included in the first signal, the related signal being related to the second signal; and a second processor which acquires the program generated by the first processor and executes the acquired program to process the second signal corresponding to the first signal. More specifically, the first processor generates, each time the first signal is taken out from the input signal, the program for processing the second signal corresponding to the first signal, and the second processor, each time the program is acquired from the first processor, executes the program and deletes a program that has been executed.

For example, the input signal is a bitstream which is coded audio signals (PCM signals), and a frame includes the first signal and the second signal. When the input signal is a bitstream in the AAC, Huffman codes generated by coding using a variety of Huffman codebooks, are packed into the second signal in the bitstream. When the input signal is a bitstream in the DTS, a variety of variable length coding (VLD) methods such as the Huffman coding and the Rice coding are applied, for example, for each frame. In addition, the first signal includes the related signal for deriving a control signal indicating a configuration of the second signal, for example, the way a signal is coded and the way the coded signal is stored in the second signal.

Thus, in the present invention, two processors are provided. The first processor generates the program for processing the second signal, and the second processor executes the program to process the second signal. Furthermore, the programs are sequentially deleted. More specifically, programs appropriate for processing the second signal are dynamically generated, and the programs are deleted after the programs are executed. Accordingly, in the present invention, the processing speed can be accelerated with the processing by the processors, and it is not necessary to hold a variety of programs compliant with the variety of Huffman codebooks and variable length coding methods in the signal processing apparatus in advance. Thus, it is possible to reduce the size of a program memory in the signal processing apparatus. As a result, the bitstream can be efficiently processed in a small circuit scale.

In addition, the second processor may include a dedicated command, the first processor may generate the program including the dedicated command, and the dedicated command may be described in a smaller amount of description than a description of a command for causing the first processor to execute the same processing executed by the second processor with the dedicated command.

With this, it is possible to reduce the size of the program. Thus, the circuit scale of the signal processing apparatus can be further reduced, and the processing speed can be further accelerated.

In addition, the first processor may generate the program which causes sequential execution of the dedicated commands without branching, the program including the plurality of dedicated commands.

For example, the program does not include conditional branching such as “if”. With this, the second processor can linearly process the program, the circuit structure of the second processor can be simplified, and it is possible to reduce the cost.

In addition, a plurality of fixed length codes may be packed into the second signal, the at least one related signal in the first signal may include a related signal related to a code length of the fixed length codes included in the second signal and a related signal related to the number of the fixed length codes included in the second signal, the dedicated command including a field in which a code length of the fixed length codes is set and a field in which the number of the fixed length codes is set instructs unpacking of the fixed length codes, the first processor, according to a plurality of the related signals, may identify the code length and the number of the fixed length codes included in the second signal and may generate the dedicated command with which the code length and the number have been set, the dedicated command instructing unpacking of the fixed length codes, and the second processor may unpack the same number of fixed length codes as set in the dedicated command by executing the dedicated command.

With this, the second processor can appropriately take out the fixed length codes (binary codes) from the second signal to appropriately decode the fixed length codes. Furthermore, with one dedicated command, it is possible to instruct unpacking of the fixed length codes, the code length of the fixed length codes, and the number of the fixed length codes, i.e. the number of the unpacking. Thus, it is possible to reduce the size of the program for decoding the fixed length codes. Furthermore, it is possible to accelerate the decoding of the fixed length codes.

In addition, a plurality of the Huffman codes may be packed into the second signal, the at least one related signal in the first signal may include a related signal related to an identifier of a codebook for decoding the Huffman codes included in the second signal and a related signal related to the number of the Huffman codes included in the second signal, the dedicated command including a field in which an identifier of a codebook is set and a field in which the number of the Huffman codes is set, may instruct unpacking of the Huffman code, the first processor, according to a plurality of the related signals, may identify the identifier of the codebook of the Huffman code and the number of the Huffman codes included in the second signal and may generate the dedicated command with which the code length and the number have been set, the dedicated command instructing unpacking of the Huffman codes, and the second processor may unpack the same number of Huffman codes as determined by the dedicated command using the identifier of the codebook set in the dedicated command by executing the dedicated command.

With this, the second processor can appropriately take out the Huffman codes from the second signal to appropriately decode the Huffman codes. Furthermore, with one dedicated command, it is possible to instruct unpacking of the Huffman codes, identifiers of codebooks (Huffman codebooks), and the number of the Huffman codes, i.e. the number of the unpacking of the Huffman codes. Thus, it is possible to reduce the size of the program for decoding the Huffman codes. Furthermore, it is possible to accelerate the decoding of the Huffman codes.

In addition, a plurality of Rice codes may be packed into the second signal, the at least one related signal in the first signal may include a related signal related to a code length of a fixed length part of the Rice code included in the second signal and a related signal related to the number of the Rice codes included in the second signal, the dedicated command including a field in which the code length of the fixed length part of the Rice code is set and a field in which the number of the Rice codes is set may instruct unpacking of the Rice code, the first processor, according to a plurality of the related signals, may identify the code length of the fixed length part of the Rice codes and the number of the Rice codes included in the second signal and may generate the dedicated command with which the code length and the number have been set, instructing unpacking of the Rice codes, and the second processor may unpack the same number of Rice codes as set in the dedicated command by executing the dedicated command, the Rice codes including the fixed length part having the fixed length set in the dedicated command.

With this, the second processor can appropriately take out the Rice codes from the second signal to appropriately decode the Rice codes. Furthermore, with one dedicated command, it is possible to instruct unpacking of the Rice codes, the code length of the fixed length part of the Rice codes, and the number of the Rice codes, i.e. the number of the unpacking of the Rice codes. Thus, it is possible to reduce the size of the program for decoding the Rice codes. Furthermore, it is possible to accelerate the decoding of the Rice codes.

In addition, the dedicated command may instruct detection of the number of successive 0 or the number of successive 1 and signal output, and the second processor may execute the dedicated command so that the number of successive 0 or the number of successive 1 included in the second signal is detected and the signal according to the detected number is outputted.

With this, when a Rice code is included in the second signal, for example, the second processor can detect the number of successive “0” in the Rice code and output the number in binary form to appropriately decode the Rice code. In addition, when the input signal is a bitstream in the AAC, an escape code in the AAC (escape sequence) can be appropriately processed. Furthermore, it is possible to accelerate the processing for the decoding.

In addition, a plurality of codes-to-be-processed and sign codes may be packed into the second signal, the first processor may generate a dedicated command instructing unpacking of the codes to be processed, detecting a sign code, and switching a sign, and the second processor may execute the dedicated command, so that the codes to be processed are sequentially unpacked from the second signal, a sign code corresponding to the code-to-be-processed are detected from the second signal each time the code-to-be-processed is unpacked, and the sign of the code-to-be-processed is switched to a sign indicated by the detected sign code.

For example, when a sign code “0” indicates a sign “positive”, and when a sign code “1” indicates a sign “negative”, the second processor switches the sign of the unpacked code-to-be-processed to “negative” when the sign code “1” is detected. More specifically, the second processor inverts each bit of the code-to-be-processed shown in a bit sequence. With this, it is possible to assign an appropriate sign for the codes-to-be-processed packed in the second signal. Furthermore, it is possible to accelerate the processing for the sign.

In addition, a plurality of quantized codes may be packed into the second signal, the first processor may generate a dedicated command instructing unpacking and inverse quantization of the quantized codes, and the second processor may execute the dedicated command, so that the second signals are inversely quantized by sequentially unpacking the quantized codes.

With this, it is possible to inversely quantize the quantized codes packed in the second signal appropriately at high speed.

Note that the present invention can not only be implemented as the signal processing apparatus, but also as a signal processing method, a program, a recording medium in which the program is stored, and an integrated circuit.

The signal processing apparatus according to the present invention can produce an advantageous effect that enables efficient processing of bitstream in a small circuit scale. In other words, according to the present invention, when performing decentralized processing using plural processors, it is possible to sequentially generate programs having an optimal size and execute the programs. Thus, it is possible to reduce the circuit scale while maintaining high speed.

### Further Information About Technical Background to This Application

The disclosure of Japanese Patent Application No. 2007-063204 filed on Mar. 13, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the configuration of a conventional signal processing apparatus which encodes a PCM signal;

FIG. 2 is a block diagram showing the configuration of a conventional signal processing apparatus which encodes a PCM signal;

FIG. 3 is a block diagram showing the configuration of a conventional signal processing apparatus including the multiple processors;

FIG. 4 shows a configuration of the signal processing apparatus according to the embodiment of the present invention;

FIG. 5 shows syntax of main signals included in a bitstream in the AAC, MPEG standard according to the embodiment of the present invention;

FIG. 6 shows the syntax of “section_data( )” in the AAC, MPEG standard;

FIG. 7 shows the syntax of “spectral_data( )” in the AAC, MPEG standard;

FIG. 8 shows a command bit field included in the second processor;

FIG. 9 shows an example of the command bit field in which the output address designation command is set;

FIG. 10 shows an example of the command bit field in which the Huffman decoding command is set;

FIG. 11 shows an example of processing program and processing in the second processor;

FIG. 12 is a flowchart showing the operation of the signal processing apparatus 100 according to the embodiment or the present invention;

FIG. 13 shows an example of the command bit field in which the binary decoding command is set according to the embodiment of the present invention;

FIG. 14 shows an example of the bitstream including a Rice code (signal B) according to the embodiment of the present invention;

FIG. 15 shows an example of the command bit field in which the Rice decoding command is set according to the embodiment of the present invention; and

FIG. 16 shows an external view of a DVD decoder in which the signal processing apparatus according to the embodiment of the present invention is provided.

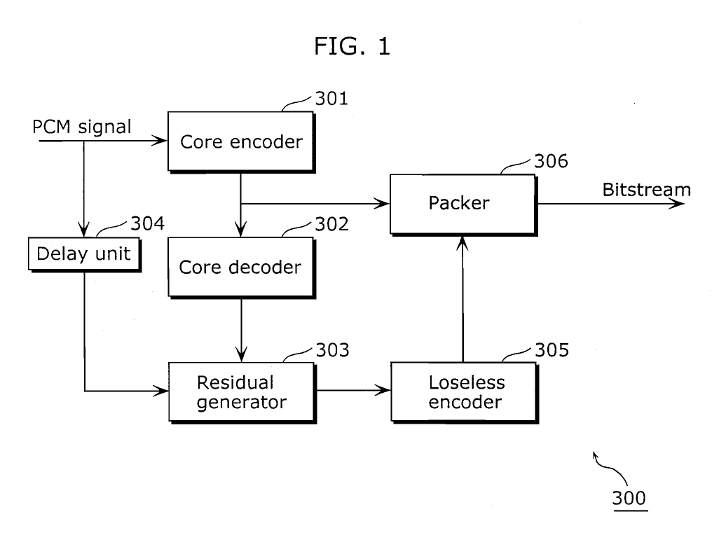

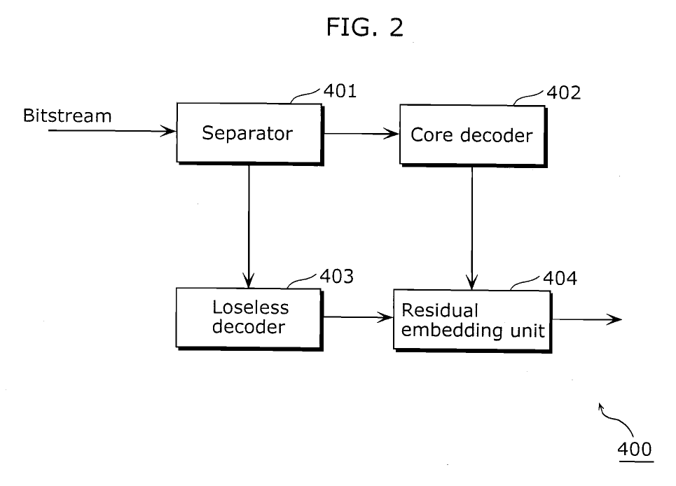

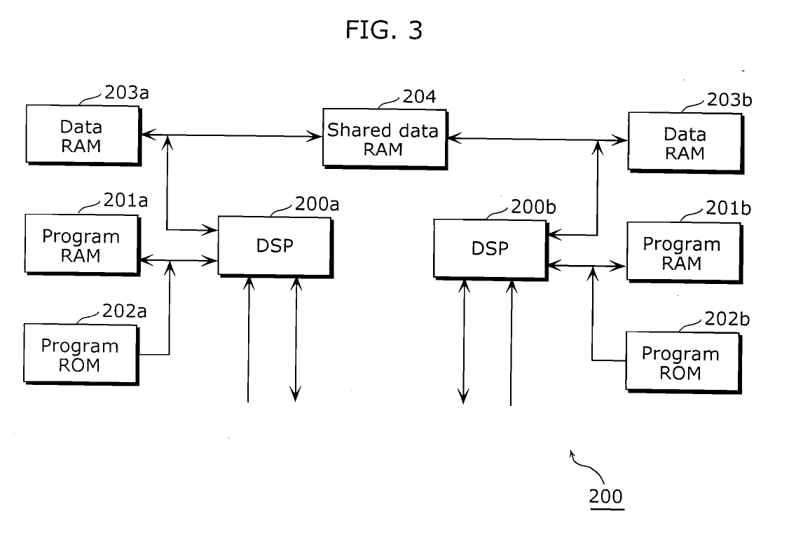

### DESCRIPTION OF THE PREFERRED EMBODIMENT(S)

The signal processing apparatus according to the first embodiment of the present invention is described with reference to the drawings.

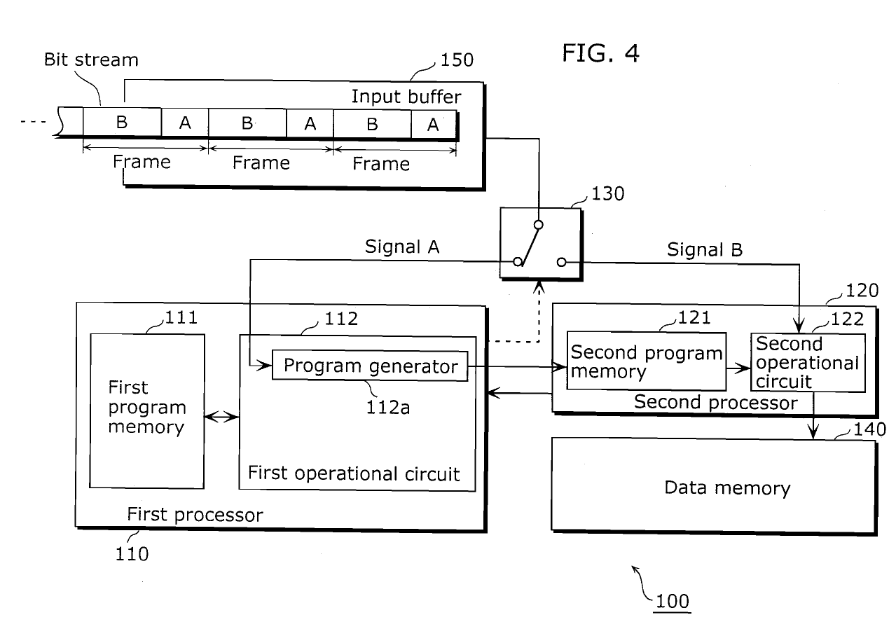

FIG. 4 is a block diagram showing the configuration of the signal processing apparatus according to the first embodiment.

The signal processing apparatus 100 decodes bitstream and is distinctive in that the signal processing apparatus 100 is configured of small circuit scale.

The signal processing apparatus 100 includes a first processor 110, a second processor 120, a selector 130, a data memory 140, and an input buffer 150.

The input buffer 150 acquires a bitstream which is an input signal and stores the bitstream. The bitstream is compressed coded signal coded in the AAC, MPEG standard, and is constructed with signals A (first signal) and signals B (second signal) that are alternately arranged. To put it differently, signals A and signals B are alternately packed in the bitstream. A frame includes a signal A and a signal B. The signal B includes audio signals which are coded by variable coding, and the signal A indicates a condition and configuration of variable coding of the signal B corresponding to the signal A.

The selector 130 switches the connection of the input buffer 150 between a first processor 110 and a second processor 120 according to the control of the first processor 110. More specifically, the selector 130 switches the connection such that the signals A of the bitstream stored in the input buffer 150 are outputted to the first processor 110 and the signals B are outputted to the second processor 120.

The first processor 110 is connected to the input buffer 150 by controlling the selector 130, and reads the signal A in the bitstream stored in the input buffer 150. The first processor 110 executes processing according to the read signals A. Furthermore, the first processor 110 connects the input buffer 150 and the second processor 120 by controlling the selector 130 when the process is finished. Furthermore, the first processor 110 connects with the input buffer 150 again by controlling the selector 130 when the first processor 110 acquires a completion signal which is described later from the second processor 120, and reads the signals A as described above and executes process according to the signals A.

As described above, the first processor 110 sequentially reads out, by controlling the selector 130, the signals A included in the bitstream from the start of the bitstream, and executes the process according to the signal A, for each signal A.

The first processor 110 includes a first program memory 111 and a first operational circuit 112. The first program memory 111 stores a program executed by the first operational circuit 112. The first operational circuit 112 reads out the signal A as described above and executes processing according to the signal A.

Here, the first operational circuit 112 includes a program generator 112a. The program generator 112a identifies a condition for the variable coding and a configuration of the signal B stored in the same frame as the signal A by analyzing the signals A each time one of the signals A is read out. Furthermore, the program generator 112a generates a program dedicated to the second processor 120 (hereinafter referred to as processing program) causing the second processor 120 to parse the signal B based on the identified content. When such a processing program is generated, the program generator 112a outputs the processing program to the second processor 120.

The second processor 120 reads the signals B in the bitstream stored in the input buffer 150 each time the second processor 120 is connected with the input buffer 150 via the selector 130. More specifically, the second processor 120 sequentially reads out the signals B from the start of the bitstream. The second processor 120 decodes each signal (code) included in the signals B by variable decoding. Furthermore, the second processor 120 outputs the completion signal described above to the first processor 110 each time processing is completed, for example, reading out or variable decoding of the signals B.

The second processor 120 includes a second program memory 121 and a second operational circuit 122. The second program memory 121 stores a processing program generated by the program generator 112a in the first processor 110.

The second operational circuit 122 parses the signals B by reading out the processing program stored in the second program memory 121 and executing the processing program. More specifically, the second operational circuit 122 takes each signal included in the signal B (in other words, unpacks the each signal) and decodes the signals B by variable decoding. The second operational circuit 122 stores each of the signals generated by the variable decoding in the data memory 140.

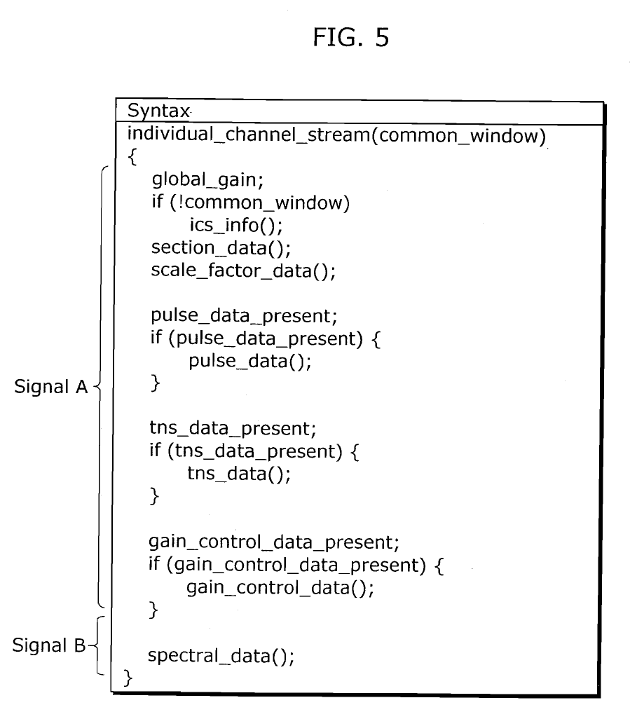

FIG. 5 shows syntax of main signals included in a bitstream. Note that the syntax shown in FIG. 5 is identical to the syntax “Table 1—Syntax of individual_channel_stream ( )” described in the MPEG (AAC) standard (ISO/IEC 13818-7:2003).

In the syntax shown in FIG. 5, the signal A is constructed with a part other than “spectral_data( )” (a part where indicated as corresponding to the signal A in the upper part of FIG. 5), the signal B is constructed with the part “spectral_data( )” (a part where indicated as corresponding to the signal B in the lower part of FIG. 5).

Note that the bitstream in the AAC, MPEG standard includes signals other than the syntax shown in FIG. 5. However, the description for these signals is omitted for the simplicity of description in the first embodiment.

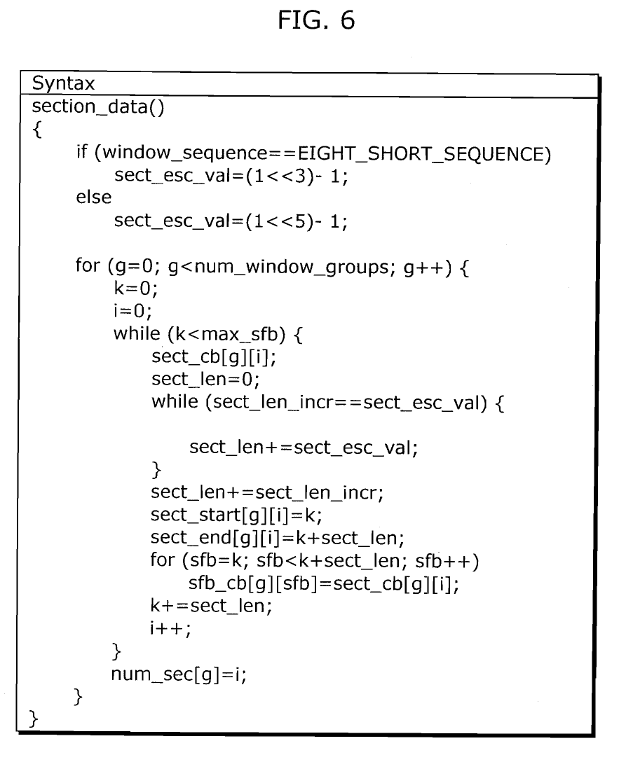

FIG. 6 shows a detailed syntax of “section_data( )” included in the part corresponding to the signal A in the syntax in FIG. 5. Note that the “section_data( )” is a main signal in the signal A and the syntax shown in FIG. 6 is identical to the syntax “Table2—Syntax of section_data( )” described in the MPEG (AAC) standard (ISO/IEC13818-7:2003).

The signal A constructed with the syntax shown in FIGS. 5 and 6 indicate variable coding condition and construction of signals included in the signal B, more specifically, the type, the order, and the number of the signals.

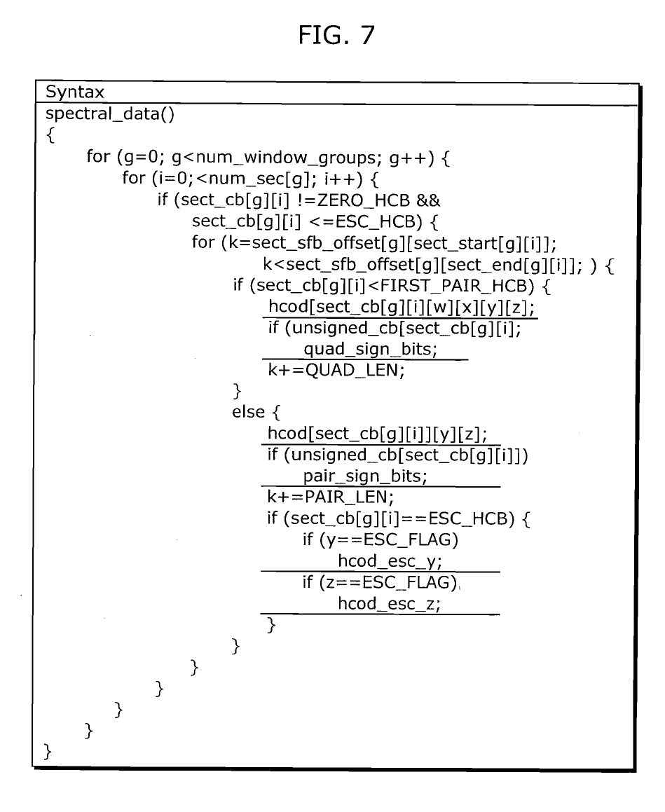

FIG. 7 shows a detailed syntax of “spectral_data( )” included in the part corresponding to the signal B in the syntax in FIG. 5. Note that the detailed syntax of “spectral_data( )” is identical to the syntax “Table20—Syntax of spectral_data( )” described in the MPEG (AAC) standard (ISO/IEC13818-7: 2003).

The signal B is constructed based on the syntax “spectral_data( )” shown in FIG. 7. In addition, among the signals shown in the syntax in FIG. 7, the underlined signals, more specifically, “hcod[sect_cb[g][i]][w][x][y][z]”, “quad_sign_bits”, “hcod[sect_cb[g][i]][y][z]”, “pair_sign_bits”, “hcod_esc_y”, and “hcod_esc_z” are signals taken from the second processor 120 (hereinafter referred to as signals to be taken). Note that the signals other than the signals to be taken, such as signals shown by the syntax in FIG. 7 and signals indicating the control construction of the syntax are hereinafter referred to as control signals. And the control signals are either identical to the signal included in the signal A (related signal) or a signal which can be derived from the related signal.

For example, as shown in FIG. 7, in the syntax of “spectral data( )”, the “for” loop controlled by “g” at the beginning indicates that a group of signals for the number of values given in the signal B includes a group of signals as many as the number of values given by “num_window_groups” in “spectral_data( )” which is the signal B. Here, the value of “num_window_groups” is the control signal described above, and is obtained by a related signal stored in the signal A by the “ics_info( )” shown in the line 3 of the syntax, “individual_channel_stream” (common_window) shown in FIG. 5. The details are described in the MPEG (AAC) standard (ISO/IEC 13818-7:2003).

Furthermore, as shown in FIG. 7, the “for” loop controlled by “i” in line 2 of the syntax in the syntax of “spectral_data( )” indicates that groups of sub-signals as many as the number of “num_sec[g]” are included for each of the groups of sub-signals included in the signal B. Here, the value of “num_sec[g]” is the control signal described above, and is acquired by a related signal stored in the signal A by the “section_data( )” shown in the line 4 of the syntax, “individual_channel_stream (common_window)” shown in FIG. 5. More specifically, as shown in FIG. 6, the value of “num_sec[g]” is stored as a related signal in the signal A by the last line of the syntax “section data( )”.

In addition, as shown in FIG. 7, the “if” branching in the lines 3 to 4 of the syntax “spectral_data( )” is confirmed by “sect_cb[g][i]”. This “sect_cb[g][i]” is also the control signal described above and stored in the signal A as a related signal by “section_data( )” in line 10 of the syntax shown in FIG. 6. Other control signals are also included in the signal A as the related signals or can be generated from the related signals.

Therefore, the program generator 112a identifies the syntax control construction (control signal) of “spectral_data( )” shown in FIG. 7 by analyzing the signal A based on a part corresponding to the signal A shown in FIG. 5 and the syntax shown in FIG. 6. More specifically, the program generator 112a identifies the type, number, and order of the signals being stored in the signal B without using the syntax of the signals B shown in FIG. 7. Furthermore, the program generator 112a generates a processing program for taking and processing the signals to be taken included in the signal B as a linearly executable program excluding a loop structure and a branching structure by “if” syntax.

Hereinafter, detailed operations of the signal processing apparatus 100 with regard to the bitstream constructed with the syntax in FIGS. 5 to 7 are described.

First of all, the first operational circuit 112 in the first processor 110 controls the selector 130 so that the input buffer 150 is connected to the first processor 110 at the beginning of the processing for acquiring the signal A from the input buffer 150.

The first operational circuit 112 in the first processor 110 takes the signals included in the signal A based on the part corresponding to the signal A in syntax in accordance with the AAC, MPEG standard. More specifically, the first operational circuit 112 analyzes the signal A and takes signals included in the signal A (parsing). Note that the parsing method of the signal A is described in detail in the MPEG (AAC) standard (ISO/IEC13818-7:2003).

The program generator 112a in the first operational circuit 112 generates a processing program for taking and processing signals included in the signal B based on the related signals taken from the signal A. The processing program is configured of a group of commands executable in the second processor 120.

More specifically, the program generator 112a takes the related signals from the signal A and uses the related signals as control signals, or derives control signals using the related signals. Such control signals indicates the type, the order, and the number of signals included in the signal B. The program generator 112a generates a processing program causing the second processor 120 to take the signals to be taken from the signal B and process the signals to be taken, by using such control signals.

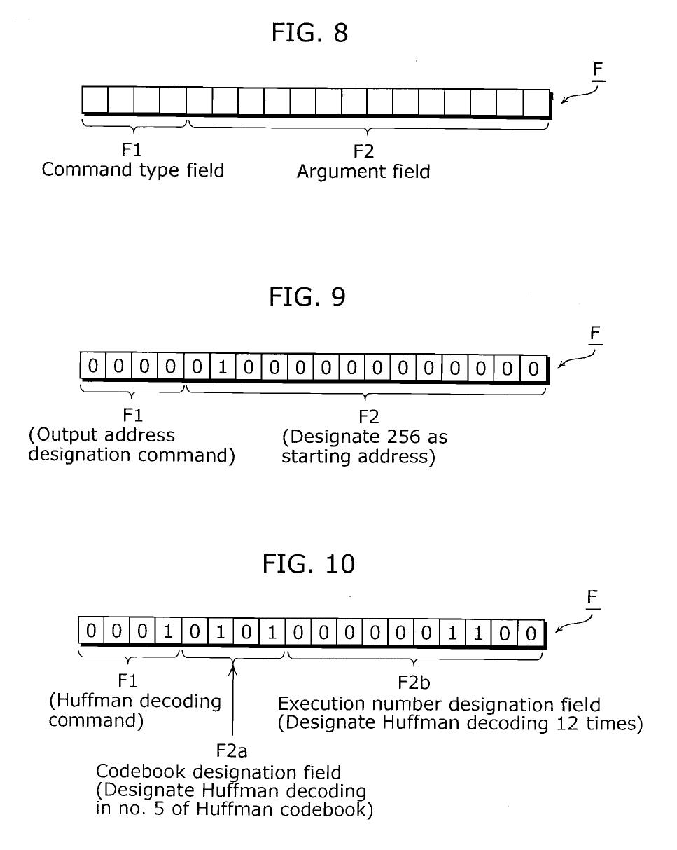

FIG. 8 shows a command bit field included in the second processor 120.

The command bit field F is constructed with a command type field F1 which gives a type of command by the 4 bits on the left and an argument field F2 by the 14 bits on the right. For example, when the command (hereinafter referred to as output address designation command) designates the starting address to which the signals outputted from the second processor 120 (hereinafter referred to as output signals), “0000” is set to the 4 bits of the command type field F1. In addition, when the command is for Huffman decoding, “0001” is set to the 4 bits of the command type field F1.

Note that, for the simplicity of description, the Huffman decoding command is described as a command instructing execution of the Huffman decoding in a restricted sense, more specifically, obtaining an output value by searching the Huffman codebook. More specifically, the Huffman decoding command instructs execution of Huffman decoding by decoding in the restricted sense by taking “hcod[sect_cb[g][i]][w][x][y][z]” or the signal “hcod[sect_cb[g][i]][y][z]” from the signal B and executing the Huffman decoding to the signals that have been taken.

The program generator 112a generates, when generating a processing program, an output address designation command described above as a command in line 1 of the processing program.

FIG. 9 shows an example of the command bit field F in which the output address designation command is set.

For example, as shown in FIG. 9, the program generator 112a generates an output address designation command in such a manner that “0000” is set to the command type field F1 in the command bit field F, and “01000000000000” is set to the argument field F2. More specifically, “0000” in the command type field F1 that are set as described above indicates that the command indicated by the command bit field F is an output address designation command, and the argument field F2 “01000000000000” indicates that the starting address of the output signal is “256”.

Next, the program generator 112a generates plural Huffman decoding commands as the commands after line 2 of the processing program. Each of the Huffman decoding commands execute Huffman decoding for “N[g][i]” times using the Huffman codebook shown by the related signal “sect_cb[g][i]” that has been acquired by acquiring the signal A.

Here, the program generator 112a derives a value of “N[g][i]” by calculating “(sect_sfb_offset[g][sect_end[g][i]]−sect_sfb_offset[g][sect_start[g][i]])/TUPPLE. Furthermore, in the above process, the program generator 112a changes the constant “QUAD_LEN” (4, more specifically) to “TLIPPLE” when “unsigned_cb[sect_cb[g][i]]” is true, and changes the constant “PAIR_LEN” (2, more specifically) to “TUPPLE” when it is false. In other words, the value of “N[g][i]” is the number of execution of the innermost “for” loop among the triple “for” loops in the syntax of “spectral_data( )” shown in FIG. 7.

The program generator 112a repeatedly generates the Huffman decoding commands described above while changing “i” in a range from 0 or more to less than “num_sect[g]”, and “g” in a range from 0 or more to less than “num_window_groups”. Note that, as described above, “num_window_groups” and “num_sect[g]” are respectively related signals included in the signal A.

More specifically, the program generator 112a generates Huffman decoding command corresponding to g=0 and i=0, as the command after line 2 of the processing program. This Huffman decoding command is for executing Huffman decoding for “N[0][0]” times using the Huffman codebook shown by “sect_cb[0][0]” that has been acquired by acquiring the signal A. Here, the program generator 112a derives a value of “N[0][0]” by calculating “(sect_sfb_offset[0][sect_end[0][0]]−sect_sfb_offset[][sect_start[0][0]]]/TUPPLE. Furthermore, in the above process, the program generator 112a changes the constant “QUAD_LEN” to “TUPPLE” when “unsigned_cb[sect_cb[0][0]]” that has been acquired by acquiring the signal A is true, and changes the constant “PAIR_LEN” to “TUPPLE” when it is false. In other words, the value of “N[0][0] is the number of execution of the innermost “for” loop among the triple “for” loops in the syntax of “spectral_data( )

shown in FIG. 7 is executed when g=0 and i=0.

FIG. 10 shows an example of the command bit field F in which the Huffman decoding command is set.

For example, as shown in FIG. 10, the program generator 112a generates a Huffman decoding command in such a manner that “0001” is set to the command type field F1 in the command bit field F, “0101” in the codebook designation field F2a that is the 4 bits on the left of the argument field F2, and “0000001100” is set to the argument field F2b that is the 10 bits on the right of the argument field F2. More specifically, “0001” in the command type field F1 that are set as described above indicates that the command indicated by the command bit field F is a Huffman decoding command, and the codebook designation field F2a “0101” specifies “5” that indicates by “sect_cb[0][0]” as a value of the Huffman codebook. More specifically, the codebook designation field F2a designates No. 5 in the Huffman codebook. The execution number designation field F2b “0000001100” designates “12” shown by “(sect_sfb_offset[0][sect_end[0][0]]−sect_sfb_offset[o][sect_starts[0[0]])/TUPPLE” as the number of execution of the Huffman decoding by the Huffman codebook. More specifically, the execution number designation field F2b designates processing for 12 times.

Furthermore, the program generator 112a generates the Huffman decoding command corresponding to g=0 and i=1, as the command after line 3 of the processing program as described above. This Huffman decoding command is for executing Huffman decoding for “N[0][1]” times using the Huffman codebook shown by “sect_cb[0][1]” that has been acquired by acquiring the signal A. Here, as described above, the program generator 112a generates the value of “N[0][1]” by calculating “(sect_sfb_offset[0][sect_end[0][1]]−sect_sfb_offset[0][sect_start[0][1]])/TUPPLE.

The program generator 112a generates a processing program executed by the second processor 120 by repeatedly generating commands in a range of “g” from 0 or more to less than “num_window” groups”, “i” from 0 or more to less than “num_sect[g]”. Furthermore, the program generator 112a has already acquired the value “num_window_groups” and “num_sect[g]” from the signal A when generating the processing program. Furthermore, here, the program generator 112a clarifies, from the signal A, that the control signals constructing the “if” condition in the syntax in FIG. 7, and the signal to be selected by the “if-else” branching. Thus, the program generator 112a generates a processing program as a linear program without loop or branching by “if”.

In this embodiment, as described above, it is possible to reduce the size of the hardware of the second processor 120 by having a linear processing program.

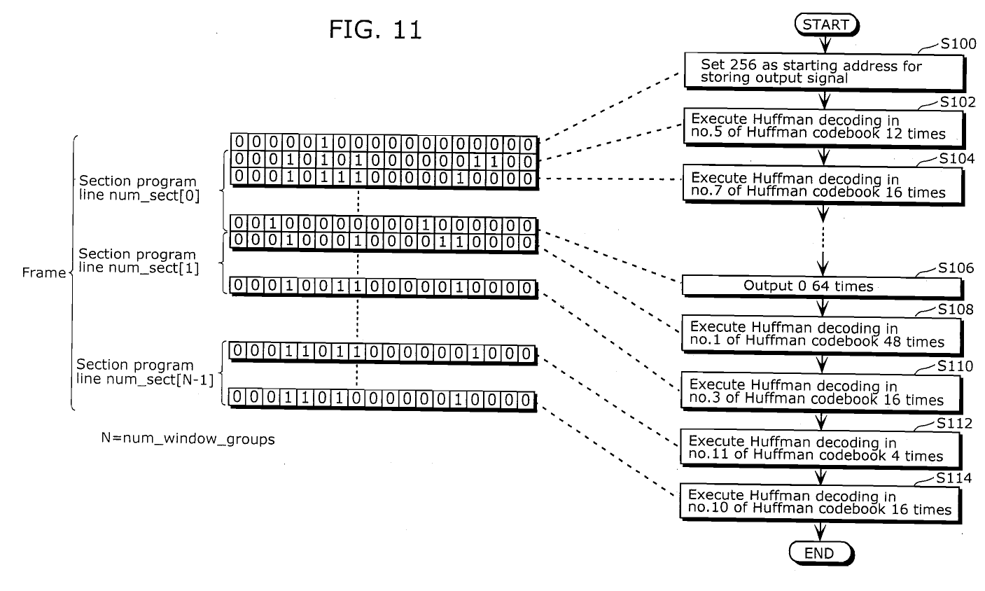

FIG. 11 shows an example of the processing program generated as described above and an example or processing of the second processor 120.

The processing program is for parsing the signal B for one frame. The command in line 1 of the processing program is an output address designation command for designating the starting address to which the output signal is stored. Section programs which are groups of commands, as many as the number (N pieces) shown by “num_window_groups” are described in line 2 or after. Each of the section programs is a program constructed by the commands as many as the number shown by “num_sect[g]” (0<=g<num_window_groups). Note that the command included in the section program is described in one line, and as described above, mainly the Huffman decoding command.

To put it differently, the second operational circuit 122 in the second processor 120 executes a section program to process a signal on the same space included in the signal B, and sequentially executes the section programs to sequentially process the signals on a temporal axis included in the signal B.

More specifically, the second operational circuit 122 sets the starting address for storing the output signal to “256” by executing the output address designation command in line 1 of the processing program (step S100).

Next, the second operational circuit 122 executes the first section program (g=0) included in the processing program. More specifically, the second operational circuit 122 repeats taking a signal having a code length of a constant “QUAD_LEN” (4, more specifically) or a constant “PAIR_LEN” (2, more specifically) from the signal B and executing the Huffman decoding on the signal that has been taken using No. 5 in the Huffman codebook for 12 times (Step S102). When the Huffman decoding is repeated, the second operational circuit 122 sequentially takes signals of the same code length from the signal B, and increments an address to which the output signal is stored (hereinafter referred to as output address) each time the Huffman decoding is performed. In addition, as shown in the syntax in FIG. 7, the second operational circuit 122 determines whether the code length to be the constant “QUAD_LEN” or the constant “PAIR_LEN” based on whether “sect_cb[0][0]” is smaller than “FIRST_PAIR_HCB” (5 in the AAC).

Furthermore, the second operational circuit 122 repeats taking a signal having a code length of a constant “QUAD_LEN” or a constant “PAIR_LEN” (Huffman codes) from the signal B and executing the Huffman decoding on the signal that has been taken using No. 7 in the Huffman codebook for 16 times (Step S104). This time, the second operational circuit 122 also sequentially takes the signal of the same code length, and increments the output address each time the Huffman decoding is executed once. In addition, the second operational circuit 122 determines, as described above, whether the code length shall be the constant “QUAD_LEN” or the constant “PAIR_LEN”, based on whether “sect_cb[0][1]” is smaller than “FIRST_PAIR_HCB”.

As described above, the second operational circuit 122 sequentially executes the Huffman decoding command included in the section program. After that, the second operational circuit 122 outputs “0” for 64 times by executing the last output command included in the section program (Step S106). Note that the output command will be described later.

After that, the second operational circuit 122 executes the second section program (g=1) included in the processing program. More specifically, the second operational circuit 122 repeats taking a signal having a code length of a constant “QUAD_LEN” or a constant “PAIR_LEN” from the signal B and executes the Huffman decoding on the signal that has been taken using No. 1 in the Huffman codebook for 48 times (Step S108). This time, the second operational circuit 122 also sequentially takes the signal of the same code length from the signal B, and increments the output address each time the Huffman decoding is executed. In addition, the second operational circuit 122 determines, as described above, whether the code length shall be the constant “QUAD_LEN” or the constant “PAIR_LEN”, based on whether “sect_cb[1][0]” is smaller than “FIRST_PAIR_HCB”.

Furthermore, the second operational circuit 122 sequentially executes the Huffman decoding command after the line 2 in the section program in the same manner as described above. Then the second operational circuit 122 sequentially executes the Huffman decoding command in “num_sect[1]” in the section program. With this, the second operational circuit 122 repeats taking a signal having a code length of a constant “QUAD_LEN” or a constant “PAIR_LEN” from the signal B and executing the Huffman decoding on the signal that has been taken using No. 3 in the Huffman codebook for 12 times (Step S110). Here, the second operational circuit 122 sequentially takes signals of the same code length from the signal B, and increments the output address each time the Huffman decoding is executed.

As described above, the second operational circuit 122 sequentially executes the section program included in the processing program, and finally, executes the Nth (g=N−1) section program included in the processing program. More specifically, the second operational circuit 122 repeats taking a signal having the same code length from the signal B and executing the Huffman decoding on the signal that has been taken using No. 11 in the Huffman codebook for 4 times (Step S112). Furthermore, the second operational circuit 122 sequentially executes the Huffman decoding command after the line 2 in the section program. Furthermore, the second operational circuit 122 repeats taking a signal having the same code length as described above from the signal B and executing the Huffman decoding on the signal that has been taken using No. 16 in the Huffman codebook for 16 times (Step S114). Note that the second operational circuit 122 increments the output address each time the Huffman decoding is executed in Steps S112 to S114 in the same manner as described above.

Here, the output commend in the last line of the first (g=0) section program included in the processing program is described. The output command instructs outputting 0 without parsing by setting “0010” in the command type field F1. Furthermore, the output command instructs repeating the processing as many as the value set in the argument field F2. The program generator 112a determines a value to be set to the argument field F2 of the output command by calculating “sect_sfb_offset[g][sect_end[g][i]]−sect_sfb_offset[g][sect_start[g][i]”. The processing performed by the output command applies to the processing for the case where, when “sect_cb[g][i]” corresponds to the processing “ZERO_HCB” in “if” syntax in line 3 of the syntax of “spectral_data( )”, and when “sect_cb[g][i]” is larger than “ESC_HCB”. When the output command is executed, the second operational circuit 122 generates 0 as an output value, and outputs the 0 for 64 times without performing Huffman decoding.

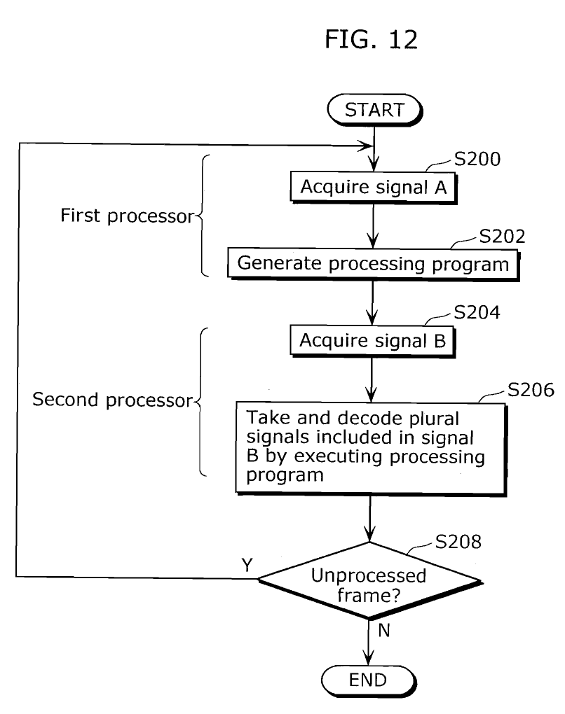

FIG. 12 is a flowchart showing the operation of the signal processing apparatus 100 according to this embodiment.

First of all, the first processor 110 in the signal processing apparatus 100 acquires the signal A among the unprocessed frames in the bitstream (Step S200). Furthermore, the first processor 110 takes a plurality of related signals from the acquired signal A, uses any of the related signals that have been taken as a control signal, and generates another control signal from any of other related signals. The signal processing apparatus 100 generates a processing program using these control signals and transmits the generated processing program to the second processor 120 (Step S202).

Next, the second processor 120 in the signal processing apparatus 100 acquires a signal B among the frames described above (Step S204). The second processor 120 receives the processing program transmitted by the first processor 110, and takes out a plurality of signals included in the signal B and decode the signals by executing the processing program (Step S206). Here, the second processor 120 sequentially stores each of the signals generated by the decoding to the data memory 140. In addition, the second processor 120 transmits a completion signal to the first processor 110 when all the signals have been stored to the data memory 140.

When the completion signal has been received from the second processor 120, the first processor 110 judges whether there is an unprocessed frame in the bitstream (Step S208), and when it is determined that there is an unprocessed frame (Y in Step S208), repeats the processing from Step S200 again. In addition, when it is judged that there is no unprocessed frame (N in Step S208), the first processor 110 terminates the processing on the bitstream.

As described above, in this embodiment, the first processor 110 generates, for each frame included in the bitstream, a processing program for parsing the signal B included in a frame based on the signal A included in the frame and outputs the processing program to the second processor 120. Therefore, the second processor 120 is not necessarily store a variety of program for parsing a variety of signals B to the second program memory 121 in advance, and thus it is possible to reduce the size of the second program memory 121. In addition, the second processor 120 is capable of erasing the executed processing program which has been previously used each time a processing program is acquired from the first processor 110. As a result, it is possible to limit the size of the second program memory 121 in the second processor 120 to a size that that can only store a processing program for parsing the particular signal B.

In addition, in this embodiment, each of the commands included in the processing program, such as an output address designation command or the Huffman decoding command is a high-function command in which plural types of commands are replaced with one command, and is dedicated to the second processor 120 included in the second processor 120. For example, the Huffman decoding command is a high-function command which instructs execution of Huffman decoding, the Huffman codebook, and the number of executions. Furthermore, when instructing a processing same as the processing executed by the second processor 120 by the high-function command described in a line in the program to other processors such as the first processor 110, a command described in a few lines in the program will be necessary. More specifically, the high-function command included in the processing program is a dedicated command with a small amount of description and compact construction with respect to the second processor 120.

Therefore, in recent audio recording such as AAC and MP3 which requires a significant amount of processing, a program for executing parsing can be constructed with commands having less description amount and less number of commands. As a result, it is possible to reduce the size of program as well as to perform the parsing at high speed.

Furthermore, in this embodiment, it is possible to simplify the structure of the second operational circuit 122 since the processing program is simply constructed as a linearly executable program without a loop and a branching by “if” syntax.

Therefore, in this embodiment, it is possible to reduce the size of program memory and the size of program, and simplify the structure of the second operational circuit 122, and thus it is possible to reduce the circuit scale of the whole signal processing apparatus 100.

Here, for the simplicity of description, the Huffman decoding command above instructs the second processor 120 to execute Huffman decoding in the restricted sense by taking “hcod[sect_cb[g][i]][w][x][y][z]” or the signal “hcod[sect_cb[g][i]][y][z]” from the signal B and executing Huffman decoding to the signals that have been taken. However, there are cases where the signal B constructed by the syntax in FIG. 7 include signals such as “quad_sign_bits”, “pair_sign_bits”, and “hcod_esc_y”, and “hcod_esc_z”. Furthermore, when the signal B includes these signals, these signals needs to be taken and processed as well.

The program generator 112a may generate a Huffman decoding command that instructs, not only the Huffman decoding in the restricted sense in which an output value is generated by searching the Huffman codebook, but also the Huffman decoding in a broader sense which includes a process including post-processing based on the output value in order to efficiently process the signal B constructed by the syntax shown in FIG. 7.

Note that the program generator 112a may cause the second operational circuit 122 in the second processor 120 to interpret a Huffman decoding command as a command instructing the Huffman decoding in the broader sense by generating the Huffman decoding command in a format different from the command bit field F shown in FIG. 10. In this case, the second operational circuit 122 includes a command represented by a format different from the command bit field F shown in FIG. 10 as a command instructing the Huffman decoding in the broader sense. In addition, the program generator 112a may cause the second operational circuit 122 in the second processor 120 to interpret a Huffman decoding command as a command instructing the Huffman decoding in the broader sense by generating the Huffman decoding command in the same format as the command bit field F shown in FIG. 10. In this case, the second operational circuit 122 includes a command represented by the same format as the command bit field F shown in FIG. 10 as a command instructing the Huffman decoding in the broader sense.

The second operational circuit 122 in the second processor 120 which executes the Huffman decoding command executes, in addition to the Huffman decode in the restricted sense generating an output value by searching the Huffman codebook, post-processing based on the output value.

For example, the program generator 112a, when the Huffman codebook “sect_cb[g][i]” is smaller than “FIRST_PAIR_HCB” (indicates 5 in the case of AAC), the Huffman decoding in the restricted sense, in which “hcod[sect_cb[g][i]][w][x][y][z]” is taken and an output value is generated by searching the Huffman codebook is performed and a Huffman decoding command instructing the Huffman decoding in the broader sense which includes taking “quad_sign_bits” and processing afterwards.

In addition, the program generator 112a, when the Huffman codebook “sect_cb[g][i]” is equal to or greater than “FIRST_PAIR_HCB”, the Huffman decoding in the restricted sense, in which “hcod[sect_cb[g][i]][y][z]” is taken and an output value is generated by searching the Huffman codebook is performed and a Huffman decoding command instructing the Huffman decoding in the broader sense which includes taking “pair_sign_bits” and a processing for acquiring an escape sequence where “hcod_esc_y” or “hcod_esc_z” which are also known as escape sequences afterwards. Note that the detail of the processing is described in the MPEG (AAC) standard (ISO/IEC13818-7:2003), and thus the description is omitted.

As described above, in this embodiment, by generating a high-function command which causes execution of the plural processing described above at one time, the processing speed of the second processor 120 which executes the high-function command, and it is possible to reduce the size of the dedicated program.

Furthermore, in the AAC, the value of “hcod[sect_cb[g][i]][y][z]” that has been parsed, for example, are groups of “y” and “z”. Furthermore, the sign code “pair_sign_bits” represents the sign of “y” and “z” when either “y” or “z” is not zero. The program generator 112a may generate a Huffman decoding command in a broader sense for separating the grouped “y” and “z” into the original “y” and “z” and applying the sign shown by “pair_sign_bits” into “y” and “z” respectively.

The second operational circuit 122 in the second processor 120 performs the Huffman decoding in a restricted sense by taking “hcod[sect_cb[g][i]][y][z]” from the signal B and separate the result “y” and “z”, by executing the Huffman decoding in a broader sense. Furthermore, the second operational circuit 122 detects “pair_sign_bits” from the signal B and when the “pair_sign_bits” indicates “1”, switches the sign of “y” and “z” to, for example, “negative”.

In the same manner, the value of “hcod[sect_cb[g][i]][w][x][y][z]” which is a result of the Huffman code in a restricted sense that has been parsed, for example, are groups of “w”, “x”, “y”, and “z”. Furthermore, the sign code “quad_sign_bits” represents the sign of “w”, “x”, “y”, and “z” when “w”, “x”, “y”, or “z” are not zero, respectively. Thus, the program generator 112a may generate, a Huffman decoding command in a broader sense for causing separation of “w”, “x”, “y”, and “z” that have been grouped, and applying the sign shown by “quad sign bits” to “w”, “x”, “y”, and “z” respectively.

The second operational circuit 122 in the second processor 120 takes “hcod[sect_cb[g][i]][w][x][y][z]” from the signal B and performs the Huffman coding in the restricted sense, and separates the results into “w”, “x”, “y”, and “z”. The second operational circuit 122 detects “quad_sign bits” from the signal B and when the “quad_sign_bits” indicates “1”, switches the sign of “w”, “x”, “y”, and “z” to, for example, “negative”.

Furthermore, the program generator 112a according to this embodiment may generate a Huffman decoding command in a broader sense for causing inverse quantization such as 4/3 power processing (ŵ(4/3), x̂(4/3), ŷ(4/3), and ẑ(4/3) to the result obtained by the application of the sign.

More specifically, the command executed by the second processor 120 is a high-function command instructing, not only the Huffman decode processing in a restricted sense, but sign processing and inverse quantization as post-processing, and is a dedicated command to the second processor 120. Therefore, in such a case, it is possible to further accelerate the processing of the signal processing apparatus 100 while generating a linearly executable program to be compact.

(Variation)

In the embodiment above, the bitstream to be processed is in the AAC, MPEG standard, the program generator 112a generates a processing program mainly including a Huffman decoding command and an output command, however, the program generator 112a may generate a processing program including other command. For example, in the DTS, as shown in the Non-patent Reference 1, the binary codes (fixed length codes) and the Rice codes (variable length codes) are used in combination.

Therefore, the program generator 112a according to the variation generates, when the bitstream to be processed is the DTS, a processing program including a command for decoding binary codes (hereinafter referred to as the binary decoding command) and a command for decoding Rice codes (hereinafter referred to as Rice decoding command).

The binary code is a fixed length code having a predetermined code length. In the signal A including the binary code, number information indicating the number of binary codes stored in the signal B and code length information indicating the code length of a binary code are respectively stored as related signals. More specifically, in the signal B in the frame binary codes having the code length shown by the code length information in the signal A as many as the number shown by the number information in the signal A.

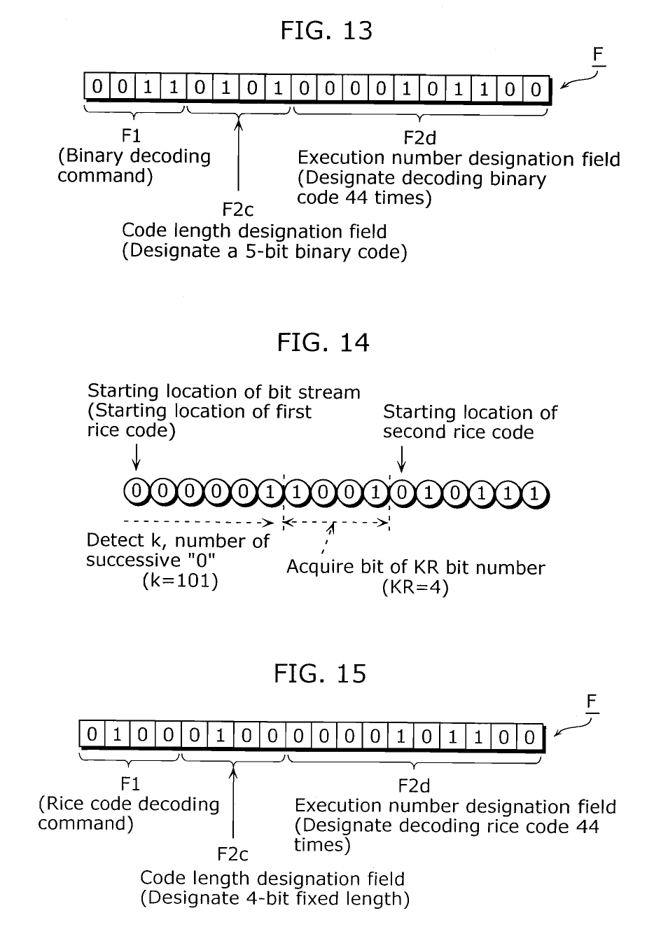

FIG. 13 shows an example of the command bit field F in which the binary decoding command is set.

For example, as shown in FIG. 13, the program generator 112a generates a binary decoding command in such a manner that “0011” is set to the command type field F1 in the command bit field F. “0101” in the codebook designation field F2c that is the 4 bits on the left of the argument field F2, and “0000101100” is set to the argument field F2b that is the 10 bits on the right of the argument field F2. More specifically, “0011” in the command type field F1 that are set as described above indicates that the command indicated by the command bit field F is a binary decoding command, and the code length designation field F2c “0101” specifies “5” as the code length of the binary code. Furthermore, the execution number designation field F2d “0000101100” designates that the number of signals to be processed (binary code) is 44, more specifically, the binary decoding shall be performed for 44 times.

Therefore, the second operational circuit 122 in the second processor 120 which executes the binary decoding command, takes out a binary code having the 5 bits of length from the signal B and decodes the signal for 44 times.

Next, a Rice code is described.

FIG. 14 shows an example of the bitstream including a rice code (signal B).

For example, as shown in FIG. 14, the bitstream is constructed as “0000011001010111 . . . ” from the left. In FIG. 14, the leftmost bit is a current starting location of the bitstream, more specifically, the starting location of the first Rice code.

When decoding the first Rice code, the number k (where k is expressed in binary form) of the successive “0” from the starting location. In this example, there are 5 successive “0”, thus k=101 (a binary form corresponds to “5” in the decimal form). Next, a bit in the KR bit number that is given in advance and is immediately after “1” that appears first from the starting location is taken from the bitstream. For example, when KR=4, the value V taken from the bitstream is “1001”.

Here, the decoded value of the first Rice code is given as “(k<<KR)|V”. Note that “<<” represents shifting bits “k” to “KR” to the left. In the example, above, k=101, and thus the decoded value of the Rice code is “1011001”.

In the same manner, the decoded value of the second Rice code is given as “(1<<4)|0111”=“10111”. Note that the number of KR bits is 4. More specifically, the code length for each Rice code increases and decreases according to the number of successive “0”, however, the number of KR bits or the bits to be taken is constant. More specifically, the bit sequence of the number of KR bits corresponds to the fixed length part of the Rice code.

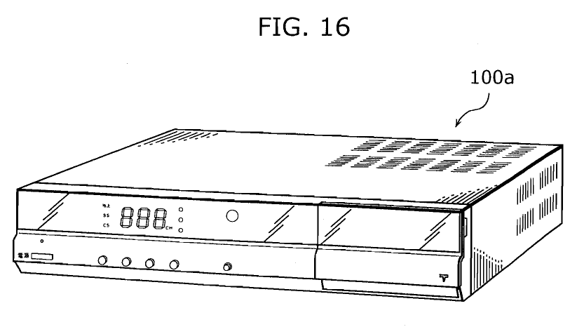

FIG. 15 shows an example of the command bit field F in which the Rice decoding command is set.

For example, as shown in FIG. 15, the program generator 112a generates a Rice decoding command in such a manner that “0100” is set to the command type field F1 in the command bit field F, “0100” in the codebook designation field F2c that is the 4 bits on the left of the argument field F2, and “0000101100” is set to the argument field F2b that is the 10 bits on the right of the argument field F2. More specifically, “0100” in the command type field F1 that are set as described above indicates that the command indicated by the command bit field F is a Rice decoding command, and the code length designation field F2c “0100” specifies “4” as the number of KR bits. Furthermore, the execution number designation field F2d “0000101100” designates that the number of Rice codes is 44, more specifically, the Rice decoding shall be performed for 44 times.

More specifically, the second operational circuit 122 in the second processor 120 that executes the Rice decoding command detects the number of successive “0” from the starting location of the signal B, takes the number of KR bits “V” based on the detection result, and calculates “(k<<KR)|V” for 44 times.

Note that the value generated by decoding each of the binary codes and the Rice codes are unsigned integer without a sign. Therefore, it is necessary to take the value to the state before coding, more specifically, to the signed integer having a sign.

Thus, the second operational circuit 122 may use the least bit of the unsigned integer as a sign code, and may convert the unsigned integer to the signed integer. More specifically, the second operational circuit 122 converts, when the unsigned integer that has been taken is “U” and a signed integer generated therein is “S”, the unsigned integer U to the signed integer S by
“If((U&1)==0)S=U>>1; else S=˜(U>>1);”

Note that “U&1” denotes the least bit of the unsigned integer, and “˜” denotes a bit inverted operator. More specifically, when the sign code which is the least bit of the unsigned integer U is “0”, the second operational circuit 122 uses the value of the upper bits excluding the least bit included in the unsigned integer U as a positive value. In addition, when the sign code which is the least bit of the unsigned integer U is “1”, the second operational circuit 122 generates a negative value by inverting the bit of the value of the upper bits excluding the least bit included in the unsigned integer U.

Such processing dealing with sign codes denoting positive or negative, as shown in the syntaxes including “if” and “else”, involves conditional branching, and thus the processing cycle is generally larger than regular processing and the size of the program increases. And in the DTS, the sign code processing always exists for each code of the binary codes and the Rice codes.

Thus, in this variation, it is possible to accelerate the processing or reduce the size of program by a binary decoding command or a Rice decoding command shown in FIGS. 13 or 15, instructing processing that includes “if” and “else”, both dealing with the sign code.

Alternatively, in accordance with the value of the command bit field F, whether the sign code processing is instructed or not may be set to each of the commands. For example, in the Rice decoding command shown in FIG. 15, when “0100” is set to the command type field F1, the Rice decoding command instructs decoding except for the processing of sign codes, and when “1100” is set to the command type field F1, the Rice decoding command instructs decoding including processing of s codes.

The signal processing apparatus according to the present invention has been described with reference to the embodiment and the variation, however, the present invention may not be limited to the present invention.

For example, in the audio coding method, processing for deriving a value corresponding to an address from a table by using a signal taken from a bitstream or a signal generated by processing the signal as the address.

Thus, the program generator 112a may generate a command instructing, not only processing for instructed by the Huffman decoding command, the binary decoding command, or the Rice decoding command, but also processing for deriving a value corresponding to a signal generated by the processing (address). More specifically, a command generated in this manner instructs processing including taking out a signal from the signal B and decoding the signal, and deriving a value corresponding to the address from the table using the signal generated by the decoding as an address. Furthermore, the command may be generated in the same format as the commend bit field shown in FIG. 10, 13, or 15, or may be generated by a different format.

Therefore, the second operational circuit 122 in the second processor 120 takes signals such as a binary code from the signal B to decode the signal by executing a command generated by the same format as the command bit field shown in FIG. 10, 13, or 15, derives a value corresponding to an address using the generated signal as a address to output the signal indicating the value.

In addition, the program generator 112a may generate a command instructing, in addition to the processing instructed by each of the commands described above, processing known as degrouping. The degrouping separates values in each digit of a signal composed of N-cimal number having P digits, more specifically, separating the signal into P pieces of data having N value. As described above, the command may be generated in the same format as the commend bit field shown in FIG. 10, 13, or 15, or may be generated by a different format.

Therefore, the second operational circuit 122 in the second processor 120 takes signals such as a binary code from the signal B to decode the signal by executing a command generated by the same format as the command bit field shown in FIG. 10, 13, or 15, degroups a value generated by the decoding, and outputs the signal generated y the degrouping.

As described above, when the program generator 112a generates a high-function command instructing the plural processing, the second operational circuit 122 in the second processor 120 includes the high-function command and executes plural processing corresponding to the high-function command.

In addition, the first operational circuit 112 in the first processor 110 may take out data from the data memory 140 in which the signals generated by the second processor 120, and process the data as necessary. For example, when the bitstream is a compressed coded signal in the AAC, the data stored in the data memory 140 is a signal generated by the Huffman decoding. This signal is a frequency spectrum signal. Therefore, the first operational circuit 112 may execute processing that takes the frequency spectrum signal from the data memory 140 and converts the temporal axis signal, more specifically, processing such as Modified Discrete Cosine Transform (MDCT).

In addition, the signal processing apparatus 100 in the embodiment and the variation may be incorporated in, for example, a DVD player.

FIG. 16 shows an external view of a DVD decoder.

The DVD decoder 100a includes the signal processing apparatus 100 in the embodiment and the variation, and decodes the bitstream and reproduces the decoded bitstream. As described above, by incorporating the signal processing apparatus 100 in the DVD recorder 100a, the circuit configuration of the DVD recorder 100a can be reduced.

In addition, the signal processing apparatus 100 in the embodiment and the variation decodes (variable length decoding) a bitstream composed of a signal stored in the input buffer 150, however, may execute other processing.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The signal processing apparatus according to the present invention can, when performing decentralized processing using plural processors, maintain high processing speed and reduce the circuit scale by sequentially generating programs having an optimal size and executing the programs. Thus, the signal processing apparatus can be applied to an AV devices and communication devices, more particularly to a DVD recorder, a BD recorder, a television receiver, a high-speed encoder, and mobile terminals.

What is claimed is:

1. A signal processing apparatus that processes an input signal in which a first signal and a second signal corresponding to the first signal are alternately packed, said signal processing apparatus comprising:
a storage unit in which the input signal is stored;
a first processor which generates a program for processing the second signal corresponding to the first signal by taking out the first signal from the input signal stored in said storage unit and by using at least one related signal included in the first signal, the related signal being related to the second signal; and
a second processor which acquires the program generated by said first processor and executes the acquired program to process the second signal corresponding to the first signal.

2. The signal processing apparatus according to claim 1,
wherein said first processor generates, each time the first signal is taken out from the input signal, the program for processing the second signal corresponding to the first signal, and
said second processor, each time the program is acquired from said first processor, executes the program and deletes a program that has been executed.

3. The signal processing apparatus according to claim 1,
wherein said second processor includes a dedicated command,
said first processor generates the program including the dedicated command, and
the dedicated command is described in a smaller amount of description than a description of a command for causing said first processor to execute the same processing executed by said second processor with the dedicated command.

4. The signal processing apparatus according to claim 3,
wherein said first processor generates the program which causes sequential execution of the dedicated commands without branching, the program including the plurality of dedicated commands.

5. The signal processing apparatus according to claim 4,
wherein a plurality of fixed length codes are packed into the second signal,
the at least one related signal in the first signal includes a related signal related to a code length of the fixed length codes included in the second signal and a related signal related to the number of the fixed length codes included in the second signal,
the dedicated command including a field in which a code length of the fixed length codes is set and a field in which the number of the fixed length codes is set instructs unpacking of the fixed length codes,
said first processor, according to a plurality of the related signals, identifies the code length and the number of the fixed length codes included in the second signal and generates the dedicated command with which the code length and the number have been set, the dedicated command instructing unpacking of the fixed length codes, and
said second processor unpacks the same number of fixed length codes as set in the dedicated command by executing the dedicated command.

6. The signal processing apparatus according to claim 4,
wherein a plurality of the Huffman codes are packed into the second signal,
the at least one related signal in the first signal includes a related signal related to an identifier of a codebook for decoding the Huffman codes included in the second signal and a related signal related to the number of the Huffman codes included in the second signal,
the dedicated command including a field in which an identifier of a codebook is set and a field in which the number of the Huffman codes is set, instructs unpacking of the Huffman code,
said first processor, according to a plurality of the related signals, identifies the identifier of the codebook of the Huffman code and the number of the Huffman codes included in the second signal and generates the dedicated command with which the code length and the number have been set, the dedicated command instructing unpacking of the Huffman codes, and
said second processor unpacks the same number of Huffman codes as determined by the dedicated command using the identifier of the codebook set in the dedicated command by executing the dedicated command.

7. The signal processing apparatus according to claim 4,
wherein a plurality of Rice codes are packed into the second signal,
the at least one related signal in the first signal includes a related signal related to a code length of a fixed length part of the Rice code included in the second signal and a related signal related to the number of the Rice codes included in the second signal,
the dedicated command including a field in which the code length of the fixed length part of the Rice code is set and a field in which the number of the Rice codes is set instructs unpacking of the Rice code,
said first processor, according to a plurality of the related signals, identifies the code length of the fixed length part of the Rice codes and the number of the Rice codes included in the second signal and generates the dedicated command with which the code length and the number have been set, instructing unpacking of the Rice codes, and
said second processor unpacks the same number of Rice codes as set in the dedicated command by executing the dedicated command, the Rice codes including the fixed length part having the fixed length set in the dedicated command.

8. The signal processing apparatus according to claim 4,
wherein the dedicated command instructs detection of the number of successive 0 or the number of successive 1 and signal output, and
said second processor executes the dedicated command so that the number of successive 0 or the number of successive 1 included in the second signal is detected and the signal according to the detected number is outputted.

9. The signal processing apparatus according to claim 4,
wherein a plurality of codes-to-be-processed and sign codes are packed into the second signal,
said first processor generates a dedicated command instructing unpacking of the codes-to-be-processed, detecting a sign code, and switching a sign, and
said second processor executes the dedicated command, so that the codes to be processed are sequentially unpacked from the second signal, a sign code corresponding to the code-to-be-processed are detected from the second signal each time the code-to-be-processed is unpacked, and the sign of the code-to-be-processed is switched to a sign indicated by the detected sign code.

10. The signal processing apparatus according to claim 4,
wherein a plurality of quantized codes are packed into the second signal,
said first processor generates a dedicated command instructing unpacking and inverse quantization of the quantized codes, and
said second processor executes the dedicated command, so that the second signals are inversely quantized by sequentially unpacking the quantized codes.

11. A signal processing method for processing an input signal in which a first signal and a second signal corresponding to the first signal are alternately packed, said signal processing method comprising:
generating, by a first processor, a program for processing the second signal corresponding to the first signal by taking out the first signal from the input signal stored in a storage unit and by using at least one related signal included in the first signal, the related signal being related to the second signal; and
acquiring the program generated by the first processor and executing the acquired program to process the second signal corresponding to the first signal by a second processor.

12. A program for processing an input signal in which a first signal and a second signal corresponding to the first signal are alternately packed, causing a first processor and a second processor to execute:
generating, by a first processor, a program for processing the second signal corresponding to the first signal by taking out the first signal from the input signal stored in a storage unit and by using at least one related signal included in the first signal, the related signal being related to the second signal; and
acquiring the program generated by the first processor and executing the acquired program to process the second signal corresponding to the first signal by a second processor.

13. An integrated circuit for processing an input signal in which a first signal and a second signal corresponding to the first signal are alternately packed, said integrated circuit comprising:
a first processor which generates a program for processing the second signal corresponding to the first signal by taking out the first signal from the input signal stored in a storage unit and by using at least one related signal included in the first signal, the related signal being related to the second signal; and
a second processor which acquires the program generated by said first processor and executes the acquired program to process the second signal corresponding to the first signal.
